(19) United States
(12) Patent Application Publication
(10) Pub. No.: US 2013/0218502 A1
(43) Pub. Date: Aug. 22, 2013

(54) TEMPERATURE COMPENSATED PRESSURE TRANSDUCER

(71) Applicant: Dresser, Inc., (US)

(72) Inventors: Roman Leon Artiuch, Houston, TX (US); Paul Stephen Hooks, Halstead (GB); Nicolae Rau, Alba Iulia (RO)

(73) Assignee: Dresser, Inc., Addison, TX (US)

(21) Appl. No.: 13/853,441

(22) Filed: Mar. 29, 2013

Related U.S. Application Data
(63) Continuation-in-part of application No. 13/401,050, filed on Feb. 21, 2012.

(51) Int. Cl. G01L 27/00

(52) U.S. Cl. CPC G01L 27/005
USPC 702/98

(57) ABSTRACT

A pressure transducer includes a sensor, a memory component, and a microprocessor. In one embodiment, a correction algorithm and set of compensation coefficients are provided and stored in the memory. The algorithm applies the compensation coefficients to determine a compensated pressure value. The pressure transducer may store the correction algorithm and the compensation coefficients for use in the field.

### CROSS-REFERENCE TO RELATED APPLICATIONS

This application is a continuation-in-part of U.S. patent application Ser. No. 13/401,050, filed on Feb. 21, 2012 and entitled “Temperature Compensated Pressure Transducer.” The content of this application is incorporated herein by reference in its entirety.

### BACKGROUND

The subject matter disclosed herein relates generally to pressure transducers and, more specifically, to temperature-compensated digital pressure transducers for use in applications requiring a high degree of accuracy.

Pressure transducers are widely used in a myriad of applications. Among the uses of pressure transducers are the indirect measurement of other variables such as fluid/gas flow, speed, water level, and altitude. There are a variety of technologies that have been used for pressure transducers, and these technologies vary in performance, and cost. The typical analog pressure transducer is characterized by relation between input pressure and an output analog signal. As with all measuring instruments, pressure transducers must be calibrated. Calibration is defined as a set of operations that establish, under specified conditions, the relationship between the values of quantities indicated by a measuring instrument or measuring system (readings) and the corresponding values realized by standards (true value). Once the relationship between the readings and true values is known the readings may be adjusted to provide a more accurate value. However the relationship between the input pressure and the output analog signal is significantly affected by temperature. Consequently, at any given pressure, variations in temperature will cause errors to be introduced in the output signal, which if left uncompensated, will cause errors leading to inaccurate pressure readings.

Compensation for temperature variations may be accomplished in a variety of ways. For example, an analog pressure transducer may be placed in a chamber where temperature and pressure can be changed. Various known pressures are applied as transducer input and output signals are measured then temperature is changed and the process is repeated. As result of this process, tables are created that describe relation between input pressure and output signal. The relation between input pressure and output analog signal may be described by a mathematical function. There is a possibility to define a few mathematical functions that describe a relation between input pressure and output signal for various temperatures during an iterative calibration process. In general, accuracy of the mathematical function depends from the number of created tables, the size of the tables and the interpolation technique. However, with this approach temperature information has to be sent to a device that is used to select the correct function to adjust pressure values based on temperature values. This method is impractical because it is difficult to define the function if the measured temperature does not match the values of temperature for which the transducer was calibrated.

Another approach is to obtain multiple readings at multiple known pressures over a range of temperatures. Tables of these values may be created and a mathematical interpolation technique may be applied to create a correction algorithm with some coefficients. If these coefficients are known and the temperature value is known, then output signal from the pressure transducer can be measured and then by using interpolation technique the temperature compensated pressure value is calculated. In general, accuracy of the function depends from the number of created tables and their size but also from interpolation technique.

Commercially available pressure transducers include transducers that provide pressure and temperature values in analog form (e.g. voltage). For these devices, correction algorithm coefficients may be stored in EEPROM located in pressure transducer. End users of the pressure transducer have to know the mathematical function describing relation between input pressure and output signal. Usually, a pressure transducer is connected to a host device. An example of a host device is a volume corrector in gas distribution lines, or a flow computer used in gas transmission lines, or similar end user electronic hardware. After the pressure transducer is connected to the host device, correction algorithm coefficients have to be provided to the host device. Usually the host device is provided with analog/digital converter that converts analog signals into digital form. The digital information is provided to a microprocessor in the host device that calculates a temperature compensated pressure value based on mathematical function and correction algorithm coefficients.

Another type of pressure transducer provides digital outputs to the host device. These pressure transducers include an analog/digital converter. Output signals in digital form are sent directly into inputs of an end user microprocessor. Correction algorithm coefficients may be stored in pressure transducer. The user of these digital-types of pressure transducers has to know the mathematical function describing relation between input pressure and output signal. Usually, after the digital-type of pressure transducer is connected for the first time into the host device, the correction algorithm coefficients are sent from the pressure transducer to the host device. The microprocessor in the host device then calculates a temperature compensated pressure value based on an applied correction algorithm and coefficients obtained during calibration process.

One application of a digital pressure transducer is as a component of a host device comprising, for example, a volume corrector in gas distribution lines, or a flow computer used in gas transmission lines. The measurement of volume flowing through a pipeline requires correction for the effects of pressure and temperature on the gas volume passing through the measuring instrument. The degree of accuracy of volume correctors or flow computers is regulated by government authorities. Charles Law and Boyle's Law are applied to adjust for pressure and temperature effects to the gas. The gas volume is converted to “Standard Pressure and Temperature values.”

To determine the volume of gas exposed to varying conditions of temperature and pressure flowing through a pipeline, accurate temperature compensated pressure measurements are required. There are three temperatures that may be measured in this type of application. These temperatures include (a) ambient temperature (volume correctors of this type may operate over a range of ambient temperatures of about −40° C. to about +70° C.), (b) the temperature of the gas flowing through the pipe, and (c) the temperature of the pressure sensing elements.

Existing pressure transducers have a number of problems when used in connection with instruments or hardware such as volume correctors. One problem is that in compensating for temperature, the temperature of the ambient air or of the gas or fluid flowing through a pipe is measured instead of the temperature of the pressure sensing element. Another problem is that when there is a reading that indicates a malfunction, the user is unable to distinguish whether the malfunction is in the pressure transducer or in the host device. Another problem is that over time, the relationship between the inputs pressure in the sensor output may change, and consequently, the complexity, expense and sometimes technical inability to recalibrate the pressure transducer in the field poses a significant problem.

### BRIEF DESCRIPTION OF THE INVENTION

The present disclosure describes pressure transducers with features that improve accuracy of pressure measurements of fluids over a wide range of temperatures. These features allow precise measurement of standardized fluid volumes delivered by, for example, pipelines and storage tanks As set forth more below, embodiments of the pressure transducers can utilize a sophisticated mathematical approach that employs a second order polynomial to correct measured pressures across a variety of temperatures. These embodiments can use a plurality of coefficients from tests on a large number of temperature and pressure sample environments. In one implementation, the tests generate six coefficients for use with the second order polynomial in a calculated correction. This feature allows the pressure transducer's rated operational range to be mapped with high resolution over both its temperature and pressure spans. For example, eight different sets of coefficients may be generated and stored in the pressure transducer so that a different set of coefficients may be selected depending on the current pressure being measured.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

Reference is now made briefly to the accompanying drawings, in which:

FIG. 1 illustrates a system including a digital pressure transducer in accordance with one embodiment of the present invention;

FIG. 2 is a flow diagram of a process for setting up a digital pressure transducer in accordance with an embodiment of the present invention;

FIG. 3 is a flow diagram of a process for calibrating a digital pressure transducer in accordance with an embodiment of the present invention;

FIG. 4 is a flow diagram of a process implemented by a digital pressure transducer in accordance with an embodiment of the present invention;

FIG. 5 is a flow diagram of a process for calibrating a digital pressure transducer in accordance with an embodiment of the present invention;

FIG. 6 is a table of pressure and temperature values obtained from a specified pressure transducer under incrementally varied pressure and temperature environments;

FIG. 7 illustrates a plurality of compensation coefficient formulas;

FIG. 8 illustrates a set of approximation coefficient formulas;

FIG. 9 illustrates a chart for mapping a pressure and temperature to select one of the compensation coefficient sets of FIG. 7;

FIG. 10 illustrates temperature compensation coefficient formulas; and

FIG. 11 illustrates a method of operating a pressure transducer having a correction algorithm stored therein.

Where applicable like reference characters designate identical or corresponding components and units throughout the several views, which are not to scale unless otherwise indicated.

### DETAILED DESCRIPTION

As set forth in more detail herein below, systems for measuring pressure can utilize a number of calibration points during a calibration phase for generating a detailed resolution of the pressure transducer's operational range. This phase generates a customized set of correction coefficients, or compensation coefficients, for subsequent use when correcting pressure measurements in the field. In one embodiment, specific field measurements may determine that one of eight different compensation coefficient sets are to be employed in a polynomial correction function. Each compensation coefficient set maps to a particular sector of temperature and pressure in the pressure transducer's operational range. In one embodiment, each coefficient set contains six coefficients which allow a high degree of correction accuracy. A second order polynomial provides the compensation function and is evaluated using the selected coefficient set.

Inputs to the polynomial correction function may include a temperature measurement from a pressure transducer temperature sensor. Additional accuracy in pressure measurement can be obtained by employing a temperature compensation function for this measured temperature. In one embodiment, a temperature compensation function may utilize one of two sets of temperature compensation coefficients to be employed in correcting a temperature measurement. An increased number of calibration points, whether for pressure compensation or temperature compensation, improves accuracy of the pressure transducer measurements and, thereby, of standardized fluid volume measurements.

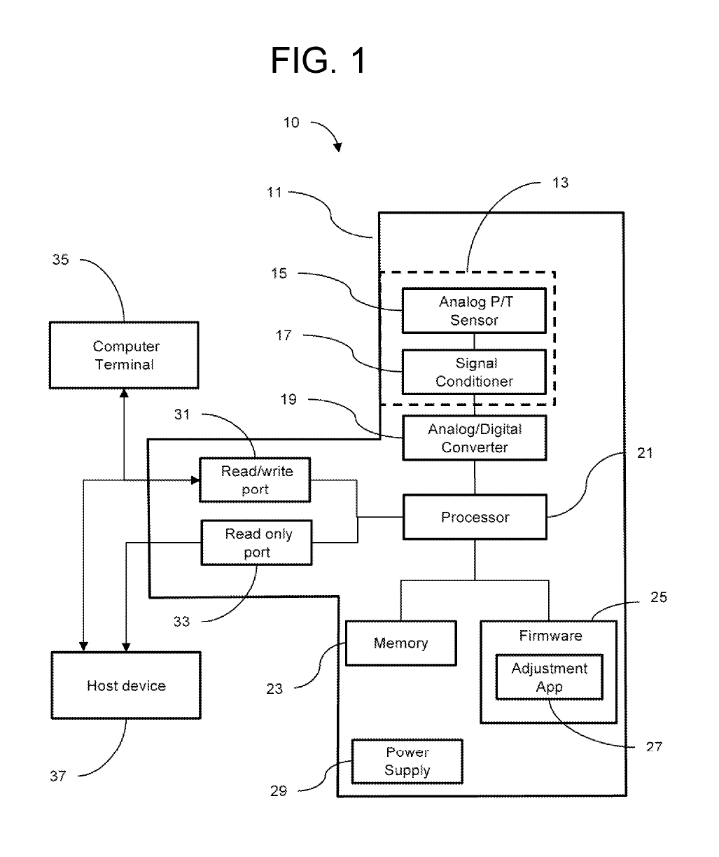

Illustrated in FIG. 1 is a system for measuring pressure 10 in accordance with one embodiment of the present invention. The system for measuring pressure 10 includes a digital pressure transducer 11. The digital pressure transducer 11 includes a pressure and temperature sensing component 13, which may comprise an analog pressure and temperature sensor 15 and a signal conditioner 17. The analog pressure and temperature sensor 15 may be one of several known types of sensors, such as bonded strain gages connected in a Wheatstone bridge configuration. The analog pressure and temperature sensor 15 provides an output that is directly proportional to the pressure and also may be used to measure temperature. Other types of sensors may include capacitive sensors electromagnetic sensors and the like, although this disclosure contemplates various combinations of pressure sensors and temperature sensor for use as the sensor 15. The signal conditioner 17 manipulates the analog signal from the analog pressure and temperature sensor 15 to be suitable as an input to an analog/digital converter 19. The analog/digital converter 19 is a device that converts the analog output received from the signal conditioner 17 into a digital number proportional to the magnitude of the analog output.

The digital pressure transducer 11 also includes a processor 21 and computer readable medium 23. Depending upon the particular embodiment, examples of the processor 21 may embody a general purpose processor, a microprocessor, a content addressable memory, a digital signal processor, an application specific integrated circuit, a field programmable gate array, any suitable programmable logic device, discrete gate or transistor logic, discrete hardware components, or any combination thereof, designed to perform the functions described herein. The processor 21 may also be realized as a microprocessor, a controller, a microcontroller, or a state machine. The processor 21 may also be implemented as a combination of computing devices, e.g., a combination of a digital signal processor and a microprocessor, a plurality of microprocessors, one or more microprocessors in conjunction with a digital signal processor core, or any other such configuration. Memory 23 is preferably an EEPROM but may be any type of memory including, RAM, ROM, or flash memory.

Firmware 25 may also be provided to control certain aspects of the functionality of the digital pressure transducer 11, such as the implementation of an adjustment application 27 that adjusts outputs to correct for temperature variations. The adjustment application 27 may implement a variety of mathematical interpolation procedures that might be applied to create a mathematical function that describes relation between input pressure and temperature and output signal. In some cases, the mathematical function may be described by polynomials with the set of coefficients.

The digital pressure transducer 11 may also include a power supply 29, which in one embodiment may be in the form of a battery or power supplied from a host device 37.

The digital pressure transducer 11 may have a read/write port 31 and a read only port 33. The read/write port 31 may be used to communicate with a computer (user) terminal 35 and/or with a host device 37. The read only port 33 may be used to communicate with the host device 37. Computer terminal 35 may be a digital processor such as a microprocessor. The host device 37 may be an instrument such as for example a volume corrector used in gas distribution lines, or a flow computer used in gas transmission lines. In one embodiment the read/write port 31 maybe a USB port. The read-only port 33 may be used to communicate with the host device 37 using an electronic component level protocol. Various methods are typically used for communication between devices at the electronic component level using protocols such as USB, IEEE 1394, RS 232, I2C, etc. The I2C protocol was developed for communication between integrated circuit (IC) chips through two bus lines. Computer terminal 35 may access application software 36 that may include applications for data interpolation and interrogation of the digital pressure transducer 11. Computer terminal 35 may be used to provide data and programs to the digital pressure transducer 11. Exemplary data and programs include calibration data, value adjustment applications, and recalibration data.

In one embodiment, some and/or all of the components of the system for measuring pressure 10 may be embodied in a single chip. Examples of chips that may be used in such cases are “system on a chip” integrated circuits and programmable “system on a chip” integrated circuits. A typical system on a chip may include a microcontroller, microprocessor or one or more digital signal processor cores. The system on a chip may also incorporate memory (e.g. ROM, RAM, EEPROM and flash memory), peripherals, external interfaces including, analog interfaces and the like. Additionally, the system on a chip may include software. A programmable system on a chip may provide integrated configurable analog and digital peripheral functions, memory, and a microcontroller on a single chip.

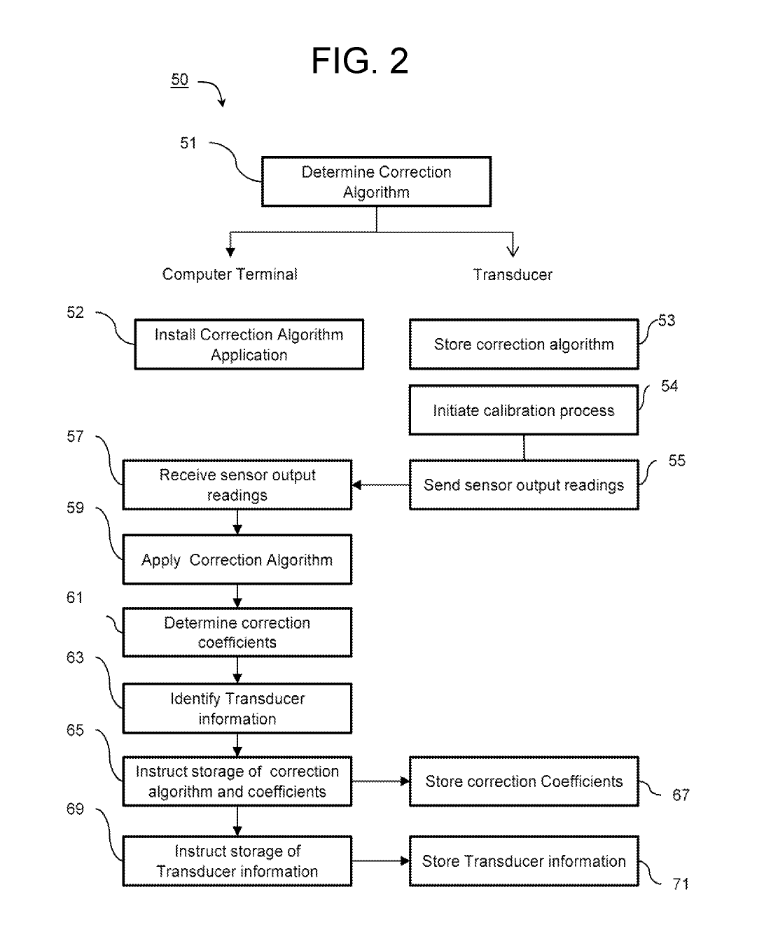

FIG. 2 illustrates an embodiment of a method 50 for instrument set-up that can be implemented on the system 10 of FIG. 1 to set-up and/or calibrate the digital pressure transducer 11. Examples of the method 50 can be coded as one or more computer programs (e.g., software, firmware, etc) in the form of computer-readable and/or executable instructions that may stored in memory (e.g., computer readable medium 23) and are configured to be executed on and/or by the computer terminal 35 (e.g., by the processor 21).

In one embodiment, the method 50 includes an initial element to determine the correction algorithm that will be applied to the data and to install the correction algorithm application (method element 52). The determination of the correction algorithm involves the balancing of data quality and performance factors such as transducer battery power and life.

Exemplary correction algorithms are often used as part of a calibration process. One of the simplest approaches to calibration of transducers is a one-point correction approach. Examples of this approach assume that the response of a sensor is linear. However, for the pressure and temperature ranges that the digital pressure transducer 11 is subjected to, the response of the analog pressure and temperature sensor 15 is a non-linear multidimensional function. This response requires, in one example, at least a two-point correction algorithm using a higher order (2 or higher) polynomial is desired. A correction algorithm can be derived for non-linear data sets by the use of polynomial interpolation. A set of data points may be replaced with an approximate polynomial function. This function may require the storage of a reduced number of polynomial correction algorithm coefficients and a curve-fitting computation that can be implemented by digital processing devices. Some embodiments may use a second, third or fourth order polynomial. A correction algorithm application may be programmed and installed in the computer terminal 35 (method element 52) and/or in the transducer (method element 53).

The method 50 may also include initiating the calibration process (method element 54) disclosed in more detail below. In one implementation, as shown in FIG. 1, the digital pressure transducer 11 may send sensor output readings to the computer terminal 35 (method element 55). Upon receipt of the sensor output readings (method element 57), the computer terminal 35 may apply the correction algorithm (method element 59) to the data for calibration purposes. From the application of the correction algorithm, a set of correction coefficients is determined (method element 61). Transducer related information such as the range digital pressure transducer 11, the serial number digital pressure transducer 11, and version of the firmware included in the digital pressure transducer 11 may be identified (method element 63). In one example, the user, through the computer terminal 35, can instruct the storage of the correction algorithm and correction coefficients into the digital pressure transducer 11 (method element 65). The digital pressure transducer 11 then may store the algorithm and correction coefficients (method element 67). Instructions to store transducer related information may be provided through terminal 35 (method element 69). The transducer related information may then be stored in the digital pressure transducer 11.

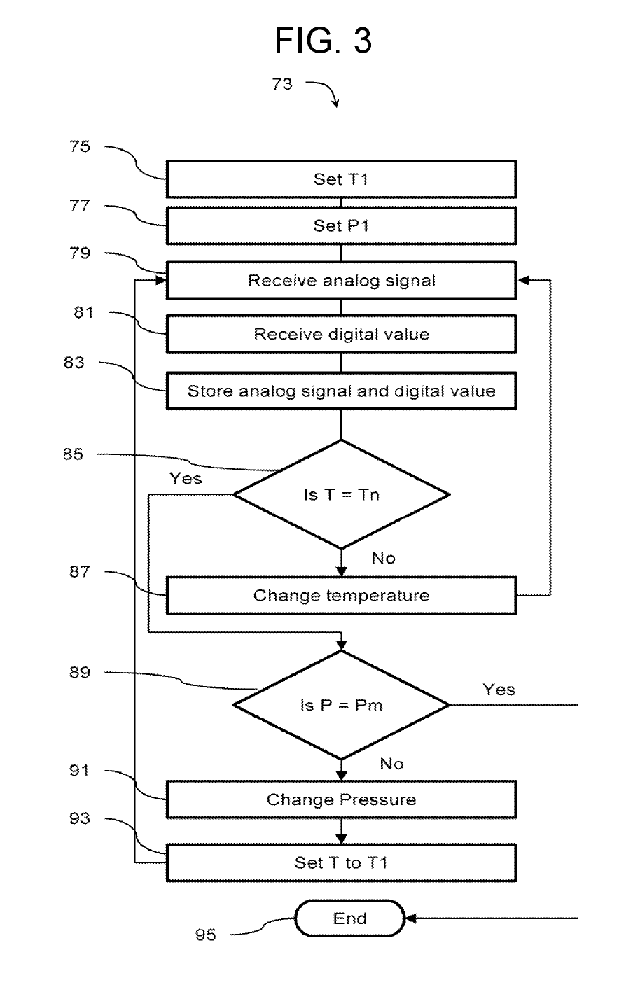

FIG. 3 illustrates an example of a method 73 for accomplishing the calibration process, e.g., calibration process of method element 54 of FIG. 2. The digital pressure transducer 11 is placed in a controlled pressure and temperature environment with a starting sensor temperature (temperature of the analog pressure and temperature sensor 15) T1 (method element 75) and a starting pressure P1 (method element 77). The temperature may be changed in predetermined increments from T1 to Tn and the pressure may be changed in predetermined increments from P1 to Pm. The initial and end temperature and pressure are determined by the operational range of the digital pressure transducer 11. The digital pressure transducer 11 may provide an analog output signal (method element 79) and a digital value associated with the output signal (method element 81). The values of the analog output signal and digital value may be stored (method element 83).

In one embodiment, the method 73 may include a determination as to whether the temperature being tested is the end temperature Tn (method element 85). If the temperature at which the digital pressure transducer 11 is being tested is not Tn, then the temperature is changed by the predetermined increment (method element 87) and measurements are made and values for the analog signal and digital values may be recorded. If the temperature at which the digital pressure transducer 11 is being tested is the end temperature Tn then a determination of whether the pressure being tested is the end pressure Pm (method element 89) is made. If the pressure being tested is not the final pressure Pm, then the pressure is changed by the predetermined increment (method element 91) and the temperature is reset to the initial temperature T1 (method element 93). If the pressure being tested is the final pressure Pm then the calibration process ends (method element 95). The results of this method are tables correlating analog signal output at a certain temperature with pressure. These tables may be used to identify the coefficients for the correction algorithm to be used with the digital pressure transducer 11.

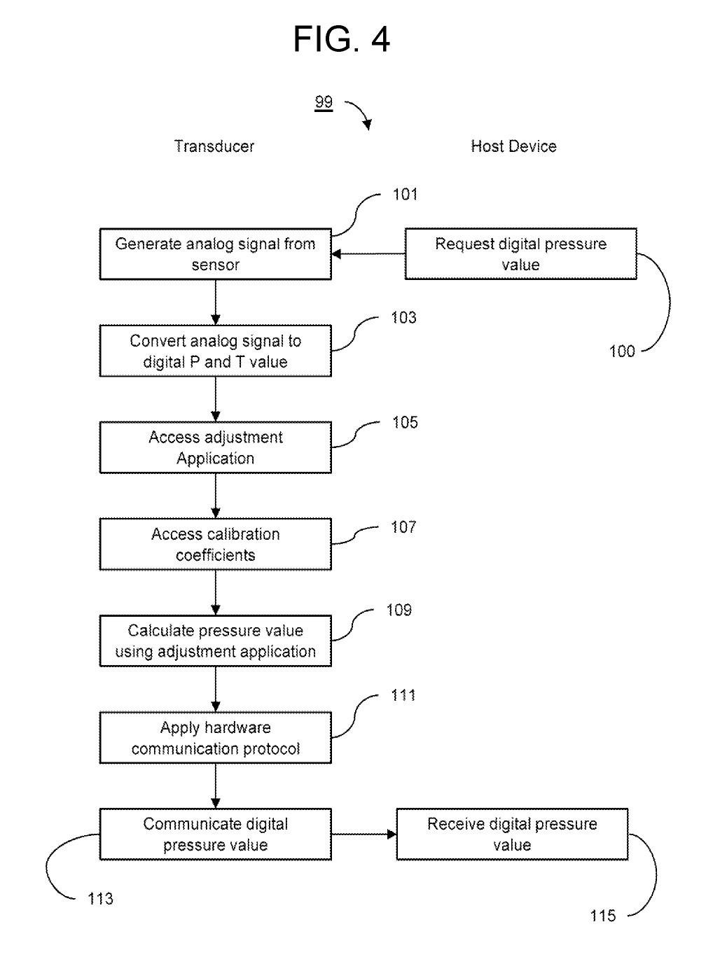

FIG. 4 illustrates an embodiment of a method 99 implemented by the digital pressure transducer 11 in combination with the host device 37. The host device 37 may send a request for a temperature adjusted digital pressure value to the digital pressure transducer 11 (method element 100). An analog signal is generated from the analog pressure and temperature sensor 15 (method element 101) which may then be converted into a digital pressure and temperature value (method element 103). The processor 21 accesses the adjustment application 27 (method element 105) and the correction algorithm coefficients (method element 107). The processor 21 then calculates a pressure value by applying the calibration application and the correction algorithm coefficients (method element 109). The resulting digital data may then be formatted in a hardware communication protocol (method element 111) in the formatted digital value is communicated to the host device 37 (method element 113). The formatted digital values are received by the host device 37 for further processing (method element 115).

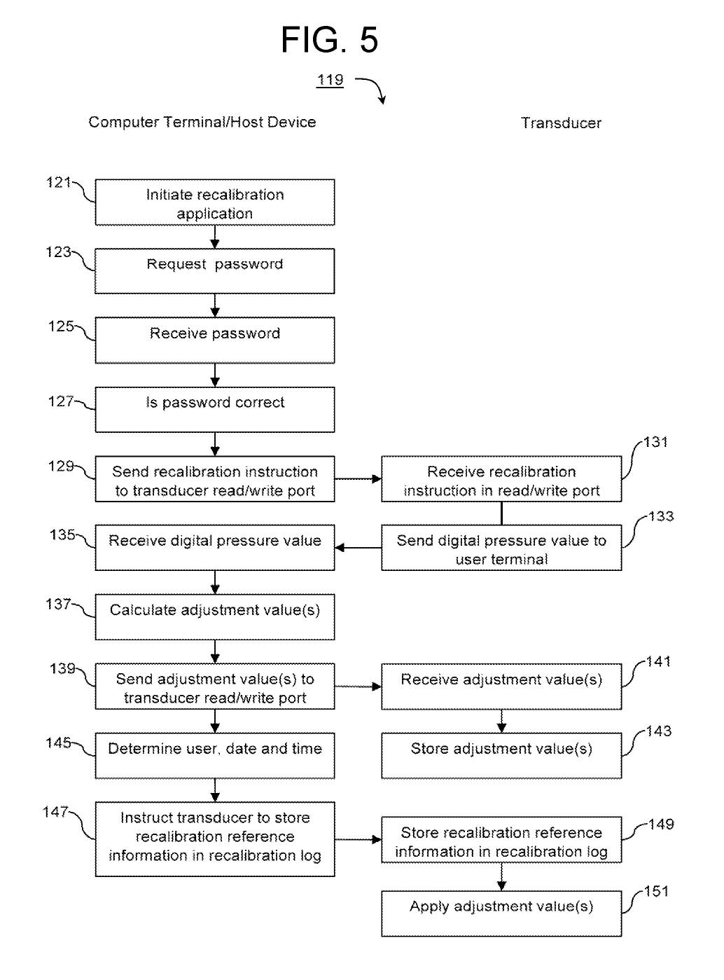

FIG. 5 illustrates a recalibration method 119 for use on the system 10 of FIG. 1 to recalibrate the digital pressure transducer 11 that may be implemented using the computer terminal 35 or the host device 37. In one embodiment, recalibration is performed in the field. A recalibration application may be initiated in computer terminal 35 or the host device 37 (method element 121). Security may be provided in the application and a request for password may be presented to the user (method element 123). Upon receipt of the password (method element 125), the password is checked (method element 127) and recalibration instructions may be sent to the read/write port 31 (method element 129) by either the computer terminal 35 or the host device 37 (external device requesting recalibration). The digital pressure transducer receives the recalibration instructions through the read/write port 31 and may provide a digital pressure value to the computer terminal 35 (or the host device 37) associated with a known pressure (method element 133). The pressure values received by the computer terminal 35 or the host device 37 (method element 135), and one or more adjustment values are calculated (method element 137). The adjustment value(s) may be calculated using known recalibration methods. For example, one point recalibration may provide an offset to correct the pressure values.

In one embodiment, another method may be used such as two point recalibration (bracketing calibration) where the two calibration points are used to bracket the range of values that will be measured. Two point recalibration may require some interpolation function to generate adjustment values. The adjustment value(s) is/are sent to the transducer read/write port 31 (method element 139) and is/are received by the transducer (method element 141). The adjustment value(s) may then be stored into memory 23 (method element 143). Optionally, the adjustment values may be calculated by the processor 21 in the digital pressure transducer 11. Additionally, other recalibration reference information such as user identification, and date and time of recalibration are may be identified (method element 145) and instructions provided to the digital pressure transducer 11 to store the recalibration reference information into a recalibration log (method element 147). The instructions would be received by the digital pressure transducer 11 wherein the recalibration reference information will be stored in a recalibration log (method element 149). Thereafter the digital pressure transducer 11 would apply the adjustment value (method element 151). Additional optional elements may be employed in this method. For example, the processor 21 may be programmed to allow a limited number of entries (recalibrations). If the limit is reached then recalibrations will not be permitted until this log is downloaded into the computer terminal 35. In that case the event of downloading is registered in a recalibration log for traceability.

In light of the foregoing embodiments describing various configurations and uses of the system of FIG. 1, the digital pressure transducer 11 serves to deliver a digital pressure value that can be verified outside host device 37. The values may be sent to a computer terminal 35 that is not connected to the host device 37. Thus, recalibration may be accomplished by the host device 37 or a separate computer terminal 35. The configuration of an embodiment of the digital pressure transducer 11 also provides for temperature correction using the temperature of the pressure and temperature sensing component 13 to be performed by the digital pressure transducer 11 rather than the host device 37.

Moreover, embodiments of the digital pressure transducer 11 serves to maintain the digital pressure transducer 11 separate from the host device 37. Correction coefficients may be stored in the digital pressure transducer 11 and the correction processing may be implemented in the digital pressure transducer 11. In a situation where the digital pressure transducer 11 fails, there is no need to replace the host device.

The digital pressure transducer 11 provides additional functionality such as for example the ability to inspect the digital pressure transducer 11 by connecting the computer terminal 35 through the read/write port 31. The temperature compensated pressure value may then be presented on the screen of the computer terminal 35. Additionally, the digital pressure transducer 11 provides the ability to periodically check if the correction algorithm coefficients have been changed (intentionally or by not controlled reasons e.g. electromagnetic radiation). One of the methods could be cyclic redundancy check (CRC). Any other method such as a checksum function may also be used. The checksum function takes a value generated from an arbitrary block of data and compares it to a recomputed value. If the checksums do not match then the data has been altered. CRC values may be stored in the digital pressure transducer 11 and if newly calculated value does not match previously stored values then the digital pressure transducer fault is set. Checking of the calibration may be done on a periodic basis (e.g. every one hour).

Embodiments of the digital pressure transducer 11 provide an additional functionality with regard to the re-use of the host device 37. For example, an end user may decide that the host device 37 (e.g. volume corrector or flow computer) should be used in another installation. In such an event, a new digital pressure transducer may be installed with the re-used host device 37 without the need of metrological verification, even if the pressure in the other installation is different. The reason for this is that the accuracy of the digital pressure transducer 11 was verified prior to installation.

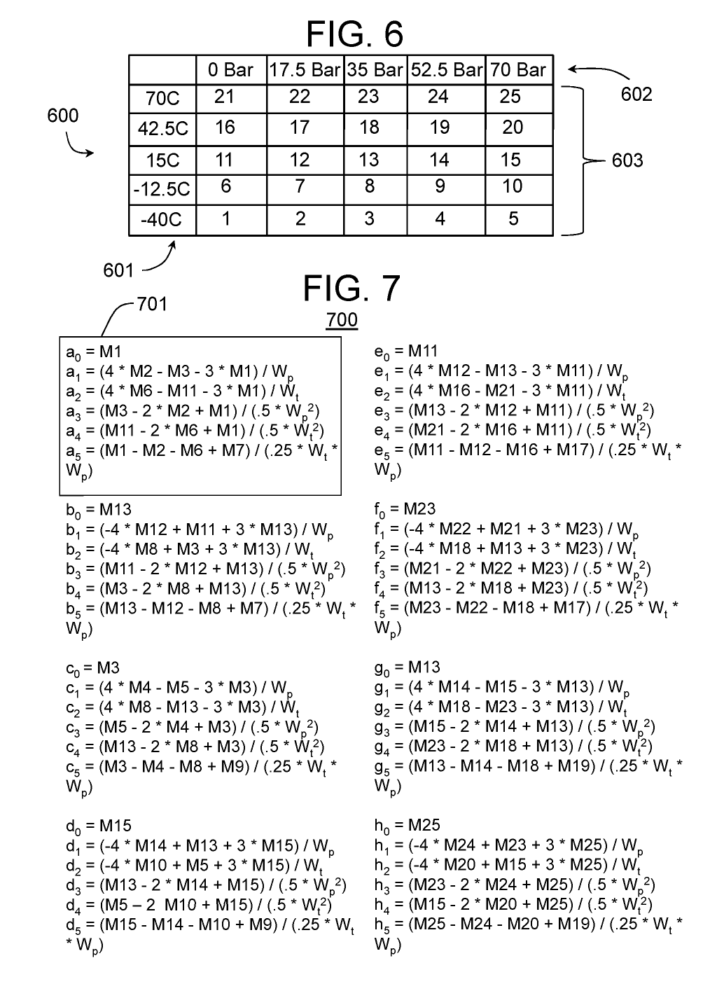

An exemplary portion of one embodiment of a correction algorithm will now be described. Referring to FIG. 6, there is illustrated an exemplary calibration table 600 for storing a matrix of digital values corresponding to the analog output signals provided by pressure transducer 11 that has undergone the calibration process 73 described above in relation to FIG. 3. Row headers 601 identify the predetermined temperature increments and column headers 602 identify the predetermined pressure increments for which measurements from pressure transducer 11 are obtained. The contents 603 of table 600 store the twenty-five outputs so obtained from pressure transducer 11. In this embodiment, predetermined temperature increments T1 to Tn are selected, wherein in one example t n=5 using the operational range of transducer 11 of about −40° C. to about +70° C., resulting in incremental test temperatures of about −40° C., about −12.5° C., about 15° C., about 42.5° C., and about 70° C. as identified in row headers 601. The predetermined pressure increments P1 to Pm are selected, wherein in one example m=5 using the operational range of transducer 11 of about 0 bar to about 70 bar, resulting in incremental test pressures of about 0 bar, about 17.5 bar, about 35 bar, about 52.5 bar, and about 70 bar, as identified in column headers 602. It should be noted that other predetermined increments n and m may be preselected as desired and that different types of pressure transducers may have different operational ranges of temperatures and pressures, i.e., different temperature span and pressure span, respectively. One factor that may determine the number of increments used for calibration purposes is the accuracy of a temperature compensated pressure measurement that is required. Greater accuracy is obtained when applying a compensation algorithm utilizing a larger number of calibration increments, i.e., smaller stepwise increments over the operational range of the pressure transducer to be calibrated.

As an exemplary reading of the table 600, the controlled temperature and pressure prepared for “environment 1” is designated by the column and row headers corresponding to the table entry labeled “1”. Thus, environment “1” was set at a known temperature of about −40° C. and the controlled pressure for that environment was set at a known pressure of about 0 bar. Each of the table entries shown in FIG. 6, i.e., 1 through 25 designating all twenty five calibration points for five different known temperatures and pressures, are similarly prepared and the responsive digital pressure and temperature measurement values provided by the pressure transducer 11 to be calibrated is recorded for each of the twenty-five test environments. The notation used herein for designating a digital pressure value provided by the digital pressure transducer 11 is designated as “M”, e.g., “M1” when the pressure transducer is subjected to the temperature and pressure of environment 1, and so on. Similarly, the notation used herein for designating a digital temperature value provided by the digital pressure transducer 11 is designated as “T”, e.g., “T1” when the pressure transducer is subjected to the temperature and pressure of environment 1, and so on.

FIG. 7 illustrates a plurality of formulas 700 for obtaining a corresponding plurality of compensation coefficients, or correction algorithm coefficients, to be used in calculating a temperature compensated pressure measurement for pressure transducer 11. In one embodiment, eight sets of compensation coefficient formulas, e.g., formulas a through h, of six coefficient formulas each, are calculated according to the exemplary coefficient sets of FIG. 7. An exemplary set of coefficient formulas 701 will now be explained. The set of coefficient formulas 701 is referred to as set “a” because it includes compensation coefficient formulas for calculating compensation coefficients a₀ through a₅. Remaining sets of coefficients and their corresponding coefficient formulas are similarly referred to herein as b through h.

As an example, coefficient a₃ is calculated as follows. The formula for calculating a₃, as shown in FIG. 7, is shown in Equation 1 below:

a₃=(M3−2*M2+M1)/(0.5*Wₚ²) (1)

This formula of Equation 1 requires the stored values from table 600 designated as M1, M2, and M3. These refer to the digital pressure output value provided by the pressure transducer 11 for table entry “1” (or calibration point 1) corresponding to environment 1 (e.g., 0 bar at −40° C.), table entry “2” corresponding to environment 2 (e.g., 17.5 bar at −40° C.), and table entry “3” corresponding to environment 3 (e.g., 35 bar at −40° C.), respectively. The terms Wₜ and Wₚ in the formulas 700 are equal to half the temperature span (in Celsius) and half the pressure span (in bar), respectively, of the pressure transducer 11. In the example pressure transducer span depicted in FIG. 7, Wₚ=35 and Wₜ=55.

In one implementation, the compensation coefficients can be stored in the memory 23 of the pressure transducer 11, e.g. via the method element 67 of the procedure illustrated in FIG. 2, to be used for future temperature pressure measurements in the field. To calculate a temperature compensated pressure measurement in the field, one or more of the sets of compensation coefficients 700, e.g., a through h, is inserted into a general equation as shown below. This general equation may also be stored in the computer-readable medium 23 of pressure transducer 11 to be calculated by pressure transducer 11, or it may be calculated by a host device 35 or host system 37 connected to pressure transducer 11. In the example below, the “a” set of six coefficients 701, designated a₀-a₅, are used, as shown below as Equation 2:

Mₚ=a₀+a₁P+a₂T+a₃P²+a₄T²+a₅PT (2)

In Equation 2, Mₚ is the measured digital pressure value output by the pressure transducer 11 in the field and T is the corresponding digital temperature value output by the pressure transducer at the same time. As described above, the temperature value may be the temperature of the pressure sensor 15. The remaining unknown variable P represents the temperature compensated pressure to be determined, and may be finally determined (solved) using a variety of computational techniques. In one embodiment, P is determined using a standard Newton-Raphson method, an example of which follows as Equation 3:

$${P}_{n + 1} = {P}_{n} - \frac{X + Y * {P}_{n} + Z * {P}_{n}^{2}}{Y + 2 * Z * {P}_{n}} \\ where \\ X = {a}_{0} - {a}_{2} * T + {a}_{4} * {T}^{2} + {M}_{p} \\ Y = {a}_{1} - {a}_{5} * T \\ Z = - {a}_{3} . \qquad ( 3 )$$

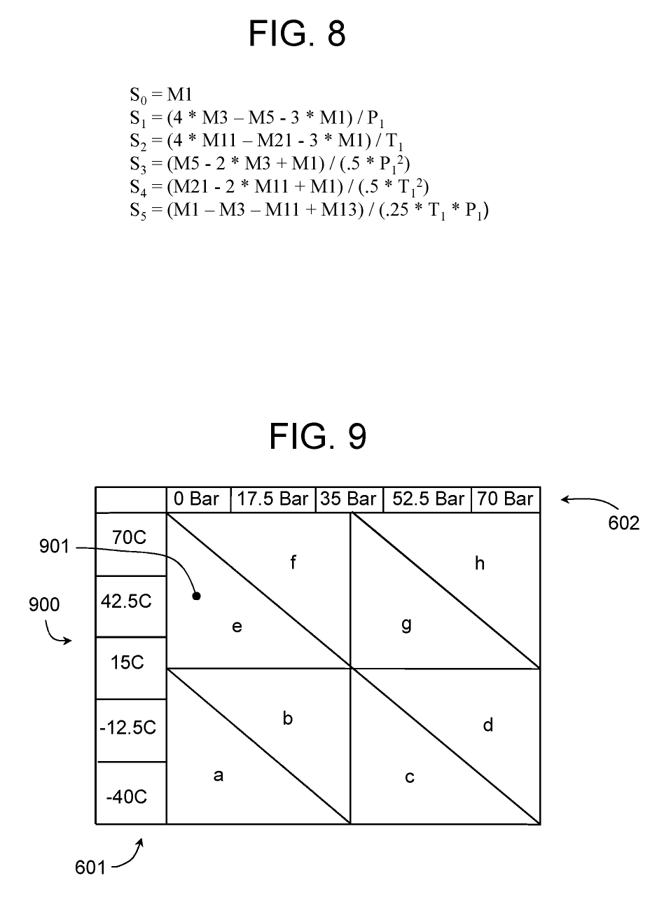

Another coefficient set is also calculated in order to determine which compensation coefficient set of the plurality of coefficient sets 700 to use for a particular temperature compensated pressure measurement in the field. This coefficient set is referred to herein as an approximation coefficient set, the “S” set comprising coefficients S₀ through S₅, and is illustrated in FIG. 8. Each coefficient in coefficient set “S” is calculated the same way as the plurality of compensation coefficients 700, as explained above with respect to the example compensation coefficient calculation for a₃. P1 and T1 of the approximation coefficient formulas represent the pressure and temperature spans of the pressure transducer, respectively. In the example pressure transducer spans depicted in FIG. 7, P₁=70 and T₁=110.

In one implementation, the approximation coefficient set is used as follows below. An initial approximate pressure measurement in the field is first obtained, using the approximation coefficients, the general equation, Equation 1, and solving for P as explained above, together with its corresponding temperature measurement. Using the solution for P thus obtained and its corresponding temperature measurement, these values are used as orthogonal coordinates to identify a sector in the chart 900 illustrated in FIG. 9. For example, an approximate compensated pressure measurement of about 0 bar and its corresponding temperature measurement of about 42.5 C would indicate a use of coefficient set e for a final temperature compensated pressure calculation because the row header 601 value of about 42.5 C and the column header 602 value of about 0 bar intersect in sector e 901 in the chart of FIG. 9. Pressure transducers having different operable pressure and temperature spans may be similarly mapped in a chart such as depicted in FIG. 9.

Thus, one embodiment of a correction algorithm disclosed herein is a two step method utilizing and solving the general equation (Equation 1) twice—one time by calculating an approximate compensated pressure in the field using the approximating coefficients of FIG. 8, and a second time using one of the sets of compensation coefficients a through h 700, selected to calculate the final compensated pressure measurement.

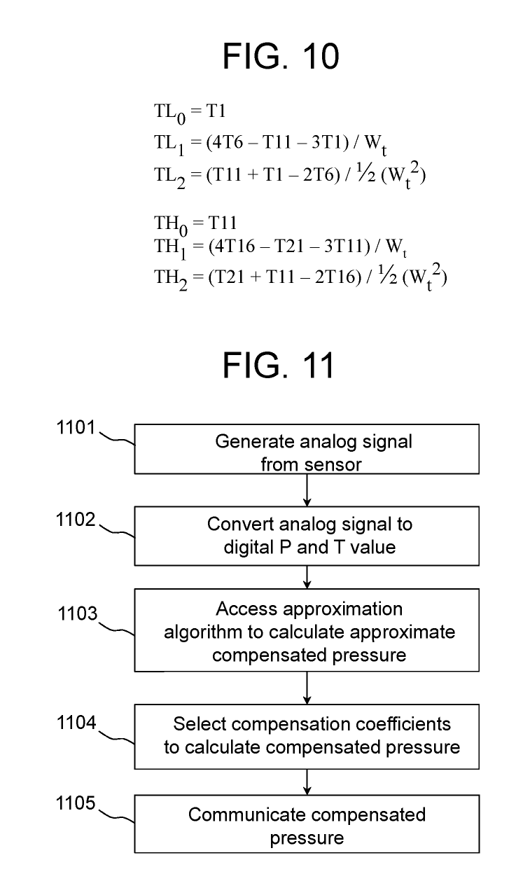

An alternative addition to the algorithm described above may include a temperature measurement compensation algorithm, as follows. Two sets of three temperature measurement compensation coefficients are generated according to the formulas shown in FIG. 10. One set of three coefficients, labeled “TLₙ” are used for temperature measurements in the lower half of the pressure sensor's temperature span, and another set labeled “THₙ” are used for temperature measurements in the upper half of the pressure sensor's temperature span. In the exemplary pressure and temperature ranges shown in FIG. 6, the upper half of the temperature range may be about 15° C. to about 70° C. and the lower half from about 15° C. to about −40° C. In initial temperature measurement may apply the TH coefficients for example, and, if the temperature measured thereby indicates, for example, about −20° C., then the temperature calibration would be run again using the TL coefficients because the about −20° C. measurement falls into the lower half of the range.

FIG. 11 illustrates a flow chart of a method 1101 of operating pressure transducer 11 based on a modification of the method 99 illustrated in FIG. 4 herein. At step 1101, an analog signal is generated from the analog pressure and temperature sensor 15 which may then be converted, at step 1102, into a digital pressure value and temperature value by A/D converter 19. The processor 21 accesses an approximation algorithm, at step 1103, to calculate an approximate compensated pressure, based on the digital pressure value from A/D converter 19, using the approximation coefficient set “S” shown in FIG. 8. At step 1104, this approximate compensated pressure and the digital temperature value from the A/D converter 19 are used as mapping coordinates on the chart shown in FIG. 9 to identify a selected set (or subset) of the compensation coefficients shown in FIG. 7. The processor 21 then calculates a compensated pressure measurement by substituting the selected compensation coefficients into general Eq. (1) and solving for P. At step 1105, this result may then be formatted in a hardware communication protocol and communicated to a host device 37 such as a volume corrector.

In light of the foregoing discussion, embodiments of the pressure transducer generate a more precise volume correction mechanism. Once the relationship between the readings and true values is known, as determined in a calibration phase, the readings may be adjusted according to a correction algorithm to provide a more accurate value. A technical effect is to improve the evaluation of fluid volumes according to standardized metrics.

The methods of the various embodiments may be embodied as one or more computer programs. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

The steps of a method or algorithm described in connection with the embodiments disclosed herein may be embodied in hardware, in firmware, in a software module executed by a processor, or in any practical combination thereof. A software module may reside in RAM memory, flash memory, ROM memory, EPROM memory, EEPROM memory, registers, a hard disk, a removable disk, a CDROM, or any other form of computer readable medium known in the art. In this regard, memory 23 can be coupled to processor 21 such that processing unit processor 21 can read information from, and write information to, memory 23. In the alternative, memory 23 may be integral to processor 21.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method of operating a digital pressure transducer, said method comprising:
receiving from a pressure sensor coupled to the digital pressure transducer a measurement of a fluid pressure;
accessing an electronic memory having a plurality of compensation coefficients stored therein;
selecting a subset of the compensation coefficients for calculating a correction to the measured fluid pressure;
calculating a corrected measured fluid pressure based on the subset of the compensation coefficients and on the received fluid pressure measurement; and
outputting a corrected measured fluid pressure.

2. The method of claim 1, further comprising:
receiving from a temperature sensor coupled to the digital pressure transducer a measurement of a temperature associated with the received fluid pressure measurement,
wherein the subset of the compensation coefficients corresponds to the measured temperature and the measured pressure.

3. The method of claim 2, wherein the measurement of the temperature reflects the temperature of the pressure sensor.

4. The method of claim 3, further comprising calculating the subset of compensation coefficients according to one or more of the following compensation coefficient formulas:
x₀=Mₙ
xᵢ=(kₙMₙ±Mₙ+kₙMₙ)÷Wₚ
x₂=(kₙMₙ±Mₙ+kₙMₙ)÷Wₜ
x₃=(Mₙ+kₙMₙ+Mₙ)÷½(Wₚ²)
x₄=(Mₙ+kₙMₙ+Mₙ)÷½(Wₜ²)
x₅=(Mₙ−Mₙ−Mₙ+Mₙ)÷¼(WₜWₚ)
wherein xₙ represents the compensation coefficients, kₙ represents a preselected constant, Mₙ represents a previous pressure measurement value determined by the pressure transducer under a known temperature and pressure environment, Wₜ represents half of the temperature span of the digital pressure transducer, and Wₚ represents half of the pressure span of the digital pressure transducer.

5. The method of claim 3, wherein the plurality of compensation coefficients comprises eight sets of compensation coefficients, and wherein each set of compensation coefficients has six coefficients.

6. The method of claim 4, further comprising calculating the measured fluid pressure according to the following pressure correction formula:
Mₚ=x₀+x₁P+x₂T+x₃P²+x₄T²+x₅PT
wherein Mₚ represents the measured fluid pressure, x₀ through x₅ represent the subset of the compensation coefficients, T represents the measured temperature, and P represents the corrected measured fluid pressure.

7. The method of claim 6, further comprising calculating the corrected measured fluid pressure using a standard Newton Raphson method according to the formula:
$${P}_{n + 1} = {P}_{n} - \frac{X + Y * {P}_{n} + Z * {P}_{n}^{2}}{Y + 2 * Z * {P}_{n}}$$
$$where$$
$$X = {x}_{0} - {x}_{2} * T + {x}_{4} * {T}^{2} + {M}_{p}$$
$$Y = {x}_{1} - {x}_{5} * T and$$
$$Z = - {x}_{3} .$$

8. The method of claim 6, further comprising:
accessing the electronic memory having a plurality of temperature correction coefficients stored therein; and
calculating a corrected temperature based on the measured temperature and the temperature correction coefficients.

9. The method of claim 8, further comprising calculating the plurality of temperature correction coefficients according to one or more of the following temperature coefficient formulas:
TL₀=T1
TL₁=(4T6−T11−3T1)÷Wₜ
TL₂=(T11+T1−2T6)÷½(Wₜ²)
TH₀=T11
TH₁=(4T16−T21−3T11)÷Wₜ
TH₂=(T21+T11−2T16)÷½(Wₜ²)
wherein TLₙ represents a temperature coefficient for correcting a measured temperature in a lower half of the pressure transducer's temperature span, THₙ represents a temperature coefficient for correcting a measured temperature in the upper half of the pressure transducer's temperature span, and Tn represents a previous temperature measurement value determined by the pressure transducer under a known temperature environment.

10. The method of claim 8, further comprising calculating an approximate pressure using one or more of the following approximation coefficients:
S₀=M1
S₁=(kₙM3−M5−kₙM1)÷P₁
S₂=(kₙM11−M21−kₙM1)÷T₁
S₃=(M5−kₙM3+M1)÷½(P₁²)
S₄=(M21−M11+M1)÷½(T₁²)
S₅=(M1−M3−M11+M13)÷¼(T₁P₁)
wherein Sₙ represents the approximation coefficients, P₁ represents the pressure span of the digital pressure transducer, and T₁ represents the temperature span of the digital pressure transducer,
wherein the subset of compensation coefficients corresponds to the approximate measured temperature.

11. A pressure transducer, comprising:
a pressure sensor configured to measure a pressure of a fluid;
a computer-readable medium comprising computer-readable instructions indicative of a polynomial and a plurality of compensation coefficients; and
a processor connected to the pressure sensor and to the computer-readable medium, the processor configured to receive a pressure measurement of the fluid and to access the computer readable medium to calculate a corrected measured pressure of the fluid based on the polynomial and on a subset of the compensation coefficients.

12. The pressure transducer of claim 11, further comprising a temperature sensor configured to measure a temperature of the pressure sensor, wherein the polynomial comprises:
Mₚ=x₀+x₁P+x₂T+x₃P²+x₄T²+x₅PT
wherein Mₚ represents the measured pressure of the fluid, x₀ through x₅ represent the selected subset of the compensation coefficients, T represents the measured temperature of the pressure sensor, and P represents the corrected measured pressure of the fluid.

13. The pressure transducer of claim 12, wherein the computer-readable medium further comprises computer-readable instructions that describe a plurality of approximation coefficients, and wherein the processor is configured to access the computer readable medium to calculate an approximate pressure of the fluid based on the approximation coefficients and to determine the subset of the compensation coefficients based on the calculated approximate pressure.

14. The pressure transducer of claim 13, wherein the selected subset of the compensation coefficients comprises one or more of:
x₀=Mₙ
x₁=(kₙMₙ±Mₙ+kₙMₙ)÷Wₚ
x₂=(kₙMₙ±Mₙ+kₙMₙ)÷Wₜ
x₃=(Mₙ+kₙMₙ+Mₙ)÷½(Wₚ²)
x₄=(Mₙ+kₙMₙ+Mₙ)÷½(Wₜ²)
x₅=(Mₙ−Mₙ−Mₙ+Mₙ)÷¼(WₜWₚ)
wherein kₙ represents a preselected constant, Mₙ represents a previous pressure measurement value determined by the pressure transducer under a known temperature and pressure environment, Wₜ represents half of the temperature span of the pressure transducer, and Wₚ represents half of the pressure span of the pressure transducer.

15. The pressure transducer of claim 14, wherein the plurality of approximation coefficients comprises one or more of:
S₀=M1
S₁=(kₙM3−M5−kₙM1)÷P₁
S₂=(kₙM11−M21−kₙM1)÷T₁
S₃=(M5−kₙM3+M1)÷½(P₁²)
S₄=(M21−M11+M1)÷½(T₁²)
S₅=(M1−M3−M11+M13)÷¼(T₁P₁)
wherein Sₙ represents the approximation coefficients, P₁ represents the pressure span of the digital pressure transducer, and T₁ represents the temperature span of the digital pressure transducer.

16. A system configured to calculate a standardized volume of a pressurized fluid, said system comprising:
a pressure sensor configured to measure a pressure of the fluid and to output a signal indicating the measured pressure;
a temperature sensor configured to measure a temperature associated with the measured pressure and to output a signal indicating the measured temperature;
an analog-to-digital converter connected to the pressure sensor and to the temperature sensor, the analog-to-digital converter configured to output a digital pressure value corresponding to the signal indicating the measured pressure and to output a digital temperature value corresponding to the signal indicating the measured temperature;
a computer readable medium comprising computer-readable instructions describing a compensation algorithm and a plurality of compensation coefficients;
a processor connected to the analog-to-digital converter and to the computer-readable medium, the processor configured to receive the digital pressure and temperature values and to access the computer-readable medium to calculate a compensated pressure of the fluid based on the compensation algorithm and on a subset of the compensation coefficients; and
a volume corrector connected to the processor, the volume corrector configured to receive the compensated pressure of the fluid and the digital temperature value, and to calculate the standardized volume of the pressurized fluid.

17. The system of claim 16, wherein the computer readable medium further comprises computer-readable instructions indicative of a polynomial, and the processor is configured to access the computer readable medium to calculate the compensated pressure of the fluid based on the subset of the compensation coefficients and the polynomial.

18. The system of claim 17, wherein the polynomial comprises:
Mₚ=x₀+x₁P+x₂T+x₃P²+x₄T²+x₅PT
wherein Mₚ represents the measured pressure, x₀ through x₅ represent the compensation coefficients, T represents the digital temperature value, and P represents the compensated pressure of the fluid.

19. The system of claim 18, wherein the computer-readable medium further comprises computer-readable instructions describing an approximation algorithm, and the processor is configured to access the computer-readable medium to calculate an approximate compensated pressure of the fluid and to determine the subset of the compensation coefficients based on the approximate compensated pressure.

20. The system of claim 19, wherein the determined subset of the compensation coefficients comprises one or more of:
x₀=Mₙ
x₁=(kₙMₙ±Mₙ+kₙMₙ)÷Wₚ
x₂=(kₙMₙ±Mₙ+kₙMₙ)÷Wₜ
x₃=(Mₙ+kₙMₙ+Mₙ)÷½(Wₚ²)
x₄=(Mₙ+kₙMₙ+Mₙ)÷½(Wₜ²)
x₅=(Mₙ−Mₙ−Mₙ+Mₙ)÷¼(WₜWₚ)
wherein kₙ represents a preselected constant, Mₙ represents a previous pressure measurement value determined by the pressure transducer under a known temperature and pressure environment, Wₜ represents half of the temperature span of the pressure transducer, and Wₚ represents half of the pressure span of the pressure transducer.
